(19) United States
(12) Patent Application Publication
(10) Pub. No.: US 2004/0130565 A1
(43) Pub. Date: Jul. 8, 2004

(54) Assist diplay apparatus for use with audio mixer

(75) Inventors: Yoshio Fujita, Hamamatsu-shi (JP); Masashi Hirano, Hamamatsu-shi (JP)

Correspondence Address: MORRISON & FOERSTER, LLP, 555 WEST FIFTH STREET, SUITE 3500, LOS ANGELES, CA, 90013-1024, US

(73) Assignee: YAMAHA CORPORATION, Hamamatsu-shi (JP)

(21) Appl. No.: 10/741,736

(22) Filed: Dec. 19, 2003

(30) Foreign Application Priority Data
Dec. 27, 2002 (JP) 2002-379309

(51) Int. Cl. G09G 5/00

(52) U.S. Cl. 345/705

(57) ABSTRACT

An assist display apparatus is designed for displaying help information on a monitor screen in association with a plurality of controls which are arranged on an audio mixing apparatus and which are operable by a user for mixing audio signals. In the assist display apparatus, a help information storage section stores help information of each of the plurality of the controls arranged on the audio mixing apparatus, the help information being capable of assisting the user in operating the controls. A receiving section receives an operation event caused by one of the plurality of the controls which has been operated by the user on the audio mixing apparatus. A display section can present a multiple of frames including an instruction frame and other frame in an overlap manner with each other on the monitor screen, and displays the help information associated with the operation event received from the audio mixing apparatus in the instruction frame disposed on top of other frame.

### BACKGROUND OF THE INVENTION

1. Field Of The Invention

The present invention relates generally to an assist display apparatus and a computer program which are capable of easily displaying the descriptions of factions and so on associated with manual controls of an audio mixing apparatus having numerous and multifunctional controls.

2. Prior Art

Conventionally, electronic equipment having various manual controls are known to have a so-called help function for displaying the functional descriptions about these controls.

For example, patent document 1 indicated below discloses a help display technology. Namely, in an electronic music apparatus having a plurality of switches of different functions for different modes, each of these switches and a help indication are associated with each other. Without executing a function assigned to that switch, a help indication screen for describing the function assigned to that switch in a current operation mode is displayed on a monitor of the electronic music apparatus.

Patent Document 1 is Japanese Published Unexamined Patent Application Hei 5-27753 (Patent No. 3306755)

Audio mixing apparatuses are designed to mix audio signals inputted from many input channels in a desired manner, impart various effects (reverberation for example) to the mixed signals if necessary, and output the resultant audio signals to two or more channels. Such an audio mixing apparatus has numerous manual controls such as switches and level-adjusting faders and volumes on its console. Because many functions are assigned to these controls, it is difficult for ordinary operators and sometimes even for expert operators to remember all of these functions of the controls.

Further, the monitor devices installed on audio mixing apparatuses are often too small, thereby making it difficult for operators to easily read help information displayed on the monitor screen. Meanwhile, expert operators who fully recognize the operations on the console may not need all or some of help functions.

### SUMMARY OF THE INVENTION

It is therefore an object of the present invention to provide an assist display apparatus and program for an audio mixing apparatus having manual and multifunctional controls, the assist display apparatus and program being adapted to provide more help information to users with ease of operation and to remove unnecessary help functions from expert users who need no more help information because they have already well versed in the operations supported by those help functions.

In carrying out the invention and according to one aspect thereof, there is provided an assist display apparatus for displaying help information on a monitor screen in association with a plurality of controls which are arranged on an audio mixing apparatus and which are operable by a user for mixing audio signals. The inventive assist display apparatus comprises a help information storage section that stores help information of each of the plurality of the controls arranged on the audio mixing apparatus, the help information being capable of assisting the user in operating the controls, a receiving section that receives an operation event caused by one of the plurality of the controls which has been operated by the user on the audio mixing apparatus, and a display section that can present a multiple of frames including an instruction frame and other frame in an overlap manner with each other on the monitor screen and that displays the help information associated with the operation event received from the audio mixing apparatus in the instruction frame disposed on top of other frame.

Preferably, the display section displaces the instruction frame to back of other frame when a predetermined time has passed after a point of time at which the help information was displayed in the instruction frame.

Alternatively, the display section closes the instruction frame when a predetermined time has passed after a point of time at which the help information was displayed in the instruction frame.

Alternatively, the display section hides the instruction frame from a view when a predetermined time has passed after a point of time at which the help information was displayed in the instruction frame.

Alternatively, the display section reduces a size of the instruction frame or relocates a position of the instruction frame such that the instruction frame does not hinder a view of other frame, when a predetermined time has passed after a point of time at which said help information was displayed in said instruction frame.

Preferably, the inventive assist display apparatus further comprises a setting section that sets on or off of an instruction mode, so that the display section operates when the instruction mode is on for displaying the help information associated with the operation event received from the audio mixing apparatus in the instruction frame disposed on top of other frame.

In carrying out the invention and according to another aspect thereof, there is provided an assist display program designed for displaying help information on a monitor screen in association with a plurality of controls which are arranged on an audio mixing apparatus and which are operable by a user for mixing audio signals. The help information is capable of assisting the user in operating the controls and is stored in a storage in correspondence to each of the controls. The inventive assist display program is executable by a computer connected to the audio mixing apparatus via a communication interface for carrying out a process comprising the steps receiving an operation event caused by one of the plurality of the controls which has been operated by the user on the audio mixing apparatus, reading out the help information corresponding to the control operated by the user from the storage in response to the operation event, and displaying the read help information associated with the operation event received from the audio mixing apparatus in an instruction frame disposed over other frame on the monitor screen.

Preferably, the displaying step displaces the instruction frame to back of other frame when a predetermined time has passed after a point of time at which the help information was displayed in the instruction frame.

Preferably, the process further comprises the step of setting on or off of an instruction mode, so that the displaying step displays the help information associated with the operation event received from the audio mixing apparatus, when the instruction mode is on, in the instruction frame disposed over other frame on the monitor screen.

### BRIEF DESCRIPTION OF THE DRAWINGS

This invention will be described in further detail by way of example with reference to the accompanying drawings.

FIG. 1 is a block diagram illustrating an exemplary configuration of an audio mixing apparatus to which the present invention is applied.

FIG. 2 is an exemplary external view of controls arranged on a mixing console.

FIGS. 3(a) through 3(c) are a diagram illustrating how help information is displayed on a remote PC.

FIGS. 4(a) and 4(b)] are a flowchart indicative of processing flows in the remote PC.

FIG. 5 is a flowchart indicative of an operation of a mixer setting & editing application.

### DETAILED DESCRIPTION OF THE INVENTION

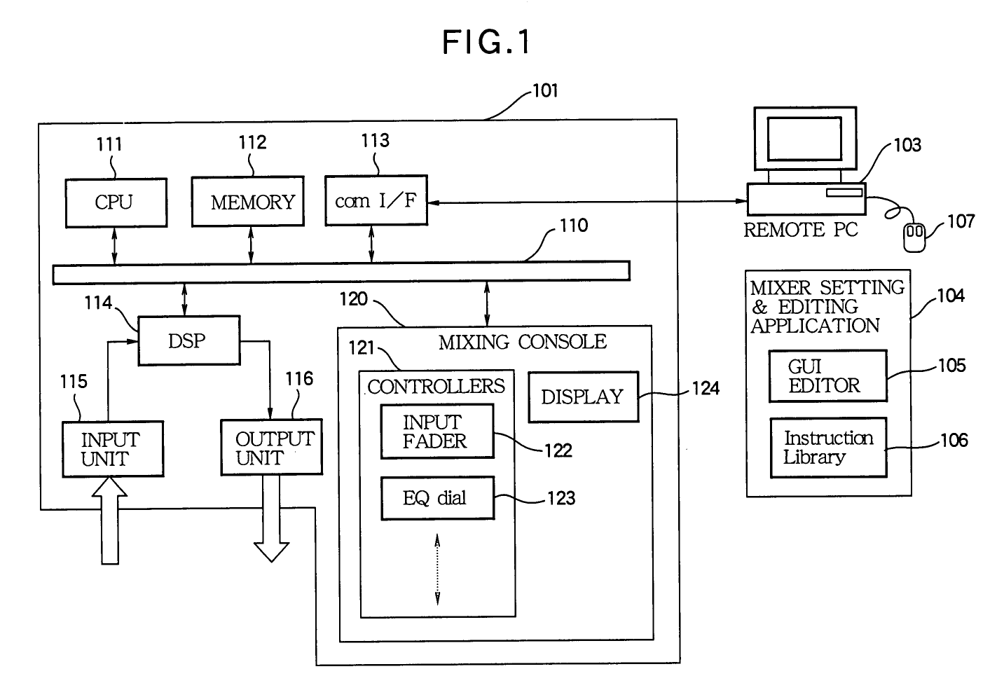

FIG. 1 shows an exemplary configuration of an audio mixing apparatus to which the present invention is applied. An audio mixing apparatus 101 has a central processing unit (CPU) 111, a memory 112, a communication interface 113, a digital signal processor (DSP) 114, an input unit 115, an output unit 116, and a mixing console 120. Reference numeral 110 denotes a bus line. A remote PC 103 is connected to the audio mixing apparatus 101 via the communication interface 113.

The CPU 111 is a processing unit for controlling the operation of the entire audio mixing apparatus. The memory 112 is a ROM for storing programs to be executed by the CPU 111 and a RAM for use as a work memory. The communication interface 113 exchanges various kinds of data with the remote PC 103. The input unit 115 is used to enter a plurality of microphone signals and line signals. The DSP 114 appropriately mixes the microphone signals and line signals entered through the input unit 115 and imparts effects as required, thereby outputting the resultant signals to given output channels of the output unit 116. The output unit 116 performs digital/analog conversion on the signals to be outputted and outputs the converted signals to a loudspeaker for example. The mixing console 120, which is operated by the user, has a plurality of controllers 121 and a display 124 on its external panel. Each controller 121 has various switches, faders 122, and equalizer adjustment dials 123.

The remote PC 103 exchanges various data with the audio mixing apparatus 101 via the communication interface 113, thereby giving various instructions to the audio mixing apparatus 101 and displaying the status of audio mixing apparatus 101. For a program to realize these functions, the remote PC 103 has a mixer setting & editing application 104. The mixer setting & editing application 104 has a GUI (Graphical User Interface) editor 105 and an instruction library 106. The GUI editor 105 is a program for enabling the user to execute, from the remote PC 103, various settings and editing operations associated with the mixer operation of the audio mixing apparatus 101. The instruction library 106 contains the help information (or instruction manuals) associated with the controls arranged on the mixing console 120. The help information is stored in the form of HTML or PDF files for example in a manner by which the pages to be displayed can be readily read out upon operation of each control. A reference numeral 107 denotes a mouse, which is a pointing device.

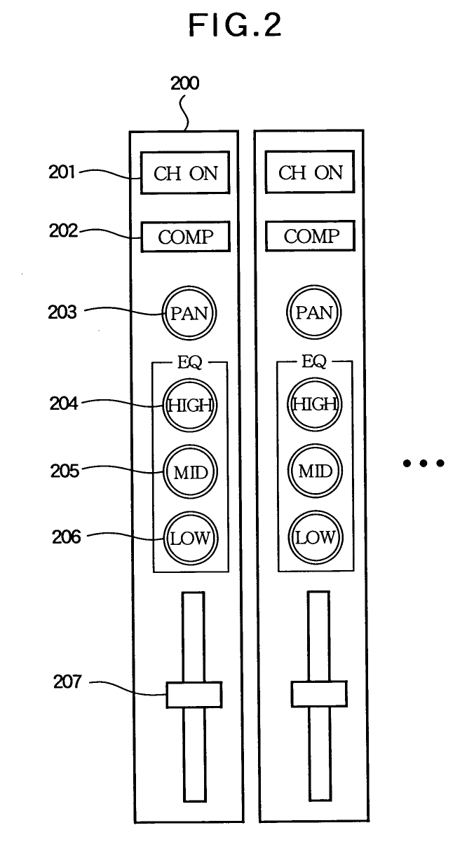

FIG. 2 shows an exemplary external view of the controllers 121 arranged on the mixing console 120. Reference numeral 200 denotes an example of a controller for one channel. Reference numeral 201 denotes an on/off switch of for that channel, and reference numeral 202 denotes a switch for turning on/off a compressor (an effecting function for compressing the dynamic range of audio signals). Reference numeral 203 denotes a panning adjustment dial for that channel, and reference numerals 204 through 206 denote equalizer adjustment dials for that channel. Reference numeral 207 denotes a fader for use in the level adjustment of that channel. These manual controls are arranged for the predetermined number of channels.

In the audio mixing apparatus 101 as described above, there are arranged various other controls in addition to the controls shown in FIG. 2, hence it is difficult for the users to recognize and understand all the functions assigned to these controls. The help information may be displayed on a display device 124 arranged on the console of the audio mixing apparatus 101, but this display device is limited in screen size and therefore cannot display enough information. Therefore, in the present embodiment, the help information is displayed on the remote PC 103 (which has a larger monitor screen) connected to the audio mixing apparatus 101 via the communication interface 113.

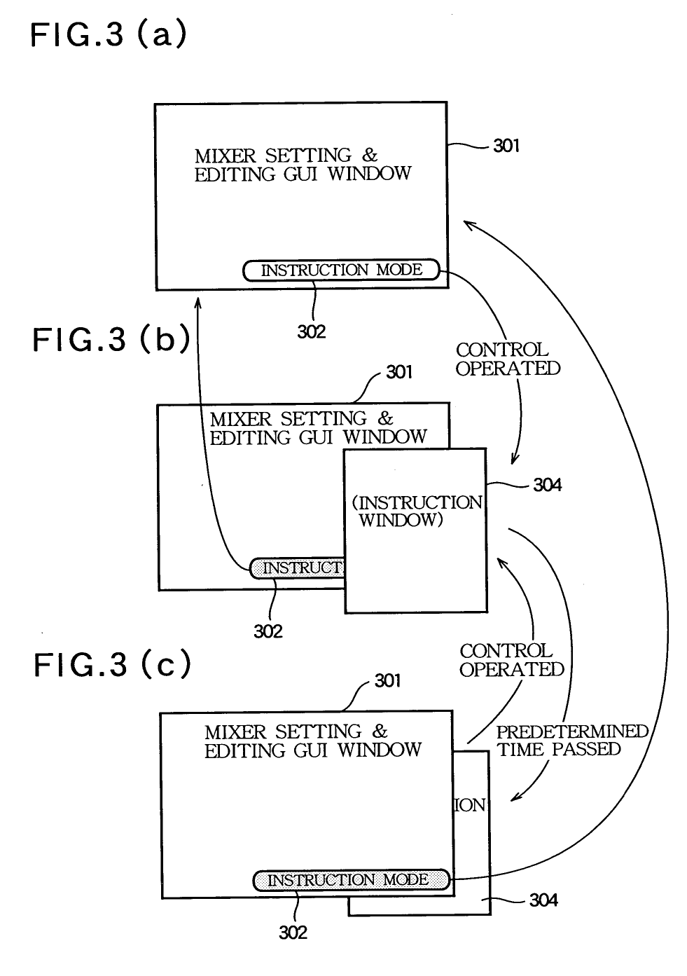

FIG. 3 shows a manner by which the help information is displayed in the remote PC 103. Reference numeral 301 denotes a mixer setting & editing GUI window which is a frame displayed on the monitor screen of the remote PC 103 when the mixer setting & editing application 104 is run on the remote PC 103. Use of this window 301 allows the user to perform various setting and editing operations on the audio mixing apparatus 101. Reference numeral 302 denotes an instruction mode button displayed in the window 301. FIG. 3(a) shows a state in which the instruction mode is off. Clicking the instruction mode button 302 with the mouse 107 from this state turns on the instruction mode. When the instruction mode button 302 is clicked again, the instruction mode is turned off. The instruction mode button is displayed in a different manner depending on its turned-on and turned-off states. For example, different display colors may be used or different graphical representations may be used by which the pressed state of the button is shown when the instruction mode is on and vice versa.

When a control of any of the controllers 121 on the mixing console 120 of the audio mixing apparatus 101 is operated by the user with the instruction mode being on, an instruction window 304 is displayed as another frame as shown in FIG. 3(b), and the help information such as the description of the function of the operated control is presented in this window 304. Further, when another control is operated on the audio mixing apparatus 101, the contents of the instruction window 304 are rewritten by other help information associated with the operated control. When a predetermined time has passed with none of the controls operated in the active state where the instruction window 304 is displayed in the front of the screen, the instruction window 304 is displaced back to the rear of the main window 301 as shown in FIG. 3(c). When a control is operated on the audio mixing apparatus 101 while the instruction window 304 is hidden in the rear, the instruction window 304 comes to be displayed in the front again as shown in FIG. 3(b), thereby displaying the help information such as the description of the function of the operated control.

When the instruction mode button 302 is clicked in the state where the instruction mode is on as shown in FIG. 3(b) or FIG. 3(c), the instruction mode is turned off, thereby closing the instruction window 304, upon which the working state shown in FIG. 3(a) is called again.

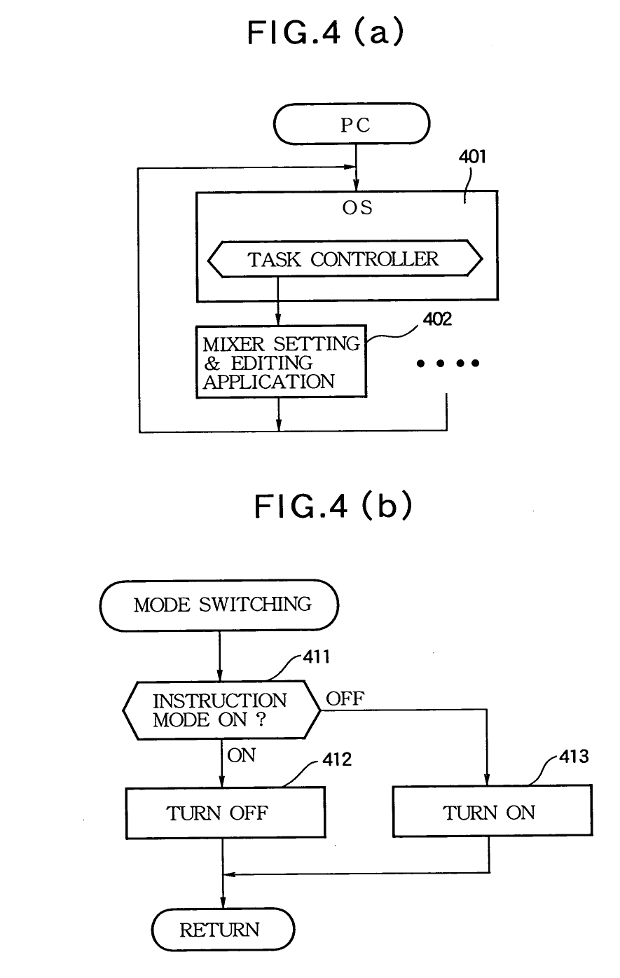

FIG. 4(a) is a flowchart indicative of the processing flow in the remote PC 103. In the remote PC 103, an operating system (OS) 401 is running, in which a task controller for controlling the execution of tasks in accordance with user instructions is operating. When the user gives an instruction to activating the mixer setting & editing application 104, the mixer setting & editing application 104 is executed as shown in step 402. The OS 401 includes a so-called window system and other applications of the mixer setting & editing application 104 may be concurrently executed under the control of the task controller.

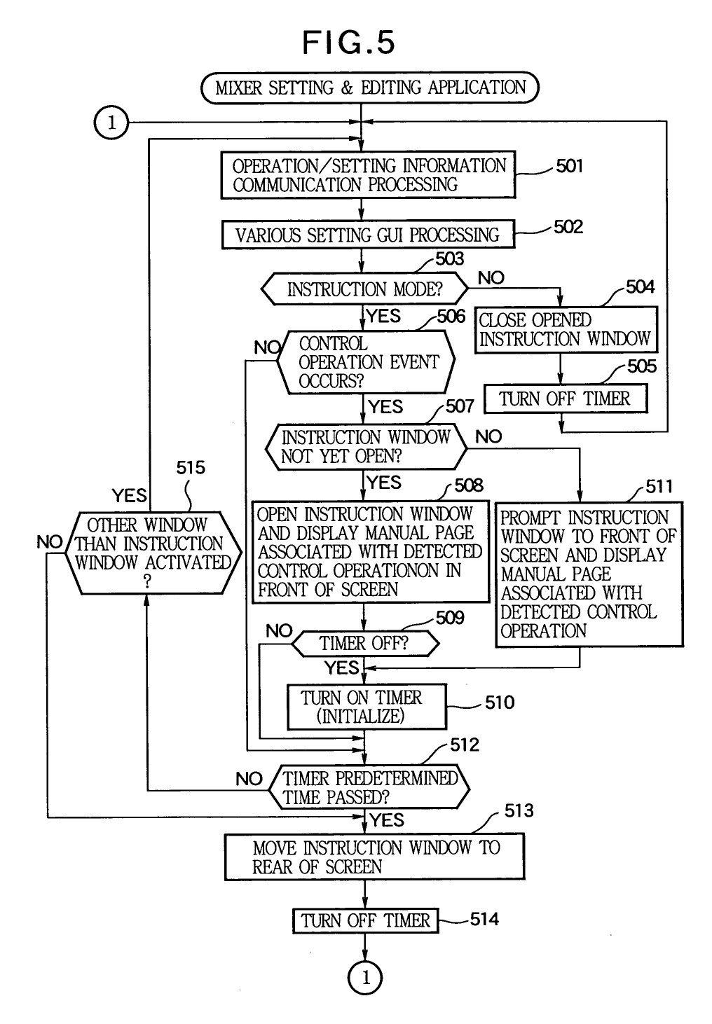

FIG. 4(b) shows a procedure of mode switching processing, one of the GUI processing operations described in step 502 of the mixer setting & editing application 104 to be described later with reference to FIG. 5. When the instruction mode button 302 described with reference to FIG. 3 is clicked, this processing is executed in the GUI processing. In step 411, a decision is made whether the current instruction mode is on or off. If the current instruction mode is found to be on, it is turned off in step S412, upon which the processing comes to an end. If the current instruction mode is found to be off, it is turned on in step 413, upon which the processing comes to an end.

FIG. 5 is a flowchart indicative of the operation of the mixer setting & editing application. In step 501, the operation setting information communication processing is executed. This processing detects the operation of each control arranged on the console of the audio mixing apparatus 101. It should be noted that when a control is operated on the audio mixing apparatus 101, it is supposed that its operational information be transmitted to the remote PC via the communication interface 113. In step 502, various setting GUI processing operations in the mixer setting & editing GUI window 301 are executed. Next, a decision is made whether the instruction mode is on. If the instruction mode is found to be off, the open instruction window if any is closed in step 504 and the timer is turned off in step 505, upon which the procedure returns to step 501.

As described above, clicking the instruction mode button 302 with the instruction mode being off executes the processing shown in FIG. 4(b) in step 502, turning on the instruction mode.

If the instruction mode is found to be on in step 503, then a decision is made in step 506 whether there is an operation event of any of the controls on the mixing console 120 of the audio mixing apparatus 101. If an operation event is found, then a decision is made in step 507 whether the instruction window is already open. If the instruction window is found to be not open, then the instruction window is opened in step 508 and displays, in the front of the screen, the instruction manual page corresponding to the operation of the control detected in step 506 as the help information. Then, a decision is made whether the timer is off in step 509. If the timer is found to be off, the timer is turned on (initialized) in step 510, upon which the procedure goes to step 512. If the instruction window is found to be already open in step 507, then this instruction window is moved to the front of the monitor screen in step 511, displaying the instruction manual page corresponding to the detected control operation (namely, the instruction manual page is read from the instruction library 106). After step 511, the procedure goes to step 510 to initialize the timer. If no control operation event is found in step 506, then the procedure goes to step 512.

In step 512, the value of the timer is read to determine whether a predetermined time has passed after the turning on of the timer (the initialization thereof). If the predetermined time is found to have passed, then the procedure goes to step 513 to put the instruction window into the rear. In step 514, the timer is turned off, upon which the procedure returns to step 501. If the predetermined time is found to have not passed, then a decision is made in step 515 whether an operation for activating any window other than the instruction window has been done. If no such an operation is found, then the procedure returns to step 501 with the instruction window kept displayed in the front, thereby continuing the mixer setting & editing processing. If any window other than the instruction window is found to have been activated, then the procedure goes from step 515 to step 513, putting the instruction window into the rear.

It should be noted that, if an operation for ending the mixing setting & editing application has been done in the GUI processing in step 502, then predetermined end processing is executed to end the above-mentioned processing.

The following briefly describes in which flow shown in FIG. 5 the help display operation described with reference to FIG. 3 is executed. First, when the instruction mode is off, the processing operations shown in steps 501 through 505 are repeated to execute the mixer setting & editing processing while executing communication with the audio mixing apparatus lot.

When the instruction mode is turned on, the processing flow of steps 501 to 502 to 503 to 506 to 512 to 515 to 501 is repeated to continue the mixer setting & editing processing. It should be noted that, at this point of time, no control operation has been done and therefore the timer is off; it is assumed that, when the timer is off, the procedure goes from step 512 to step 515. Also, at this point of time, the instruction window has not yet displayed; it is assumed that the procedure returns from step 515 to step 501.

When a control of the audio mixing apparatus is operated with the instruction mode being on, the procedure goes from step 506 to step 507 and the instruction window is displayed to execute a help display operation and turn on the timer in the flow of step steps 507 to 508 to 509 to 510 to 512. Until the predetermined time has passed, the procedure goes from step 512 to step 515. If any window other than the instruction window has not been activated, the procedure returns from step 515 to step 501. When the predetermined time has passed, the procedure goes from step 512 to step 513, thereby automatically putting the instruction window back into the rear.

It should be noted that, in the above-mentioned embodiment, the instruction window is put into the rear after passing of a predetermined time; alternatively, any one of the following manners of handling the instruction window may be employed:

(1) the instruction window is closed after a predetermined time;

(2) the instruction window is hidden (minimized) from a view of the user after a predetermined time;

(3) the instruction window is reduced in size or relocated such that the instruction window does not hinder the viewing of other windows after passing of a predetermined time; and

(4) the instruction window is put into the rear or otherwise processed in any one of the above-mentioned manners not after the passing of a predetermined time but the detection of a particular operation done on the mixing console 120 or the remote PC 103.

In the above-mentioned embodiment, help information is opened for display separately in the instruction window 304. Alternatively, a help information display area may be arranged (or opened) in the mixer setting & editing window 301 to display help information in this area.

The instruction library 106 itself or a part or all of the help information contained therein may be supplied from another computer (a server) connected separately from the remote PC. Namely, necessary help information may be downloaded from an external computer. Such an external computer may be connected via a communication protocol or a communication interface such as TCP/IP (Internet connection), IEEE1394, USB, RS-232C, or any of various wireless interfaces.

As described and according to the invention, a computer connected to audio mixing apparatuses, which generally have numerous and multifunctional controls, receives the event information about operations done on the audio mixing apparatus, and displays the help information associated with each operation done, so that the present invention allows the communication of more help information to users with ease of operation on a larger monitor screen of the computer than that of the audio mixing apparatuses. In addition, the present invention allows the detachment of those help functions if skilled users need no more assist because they have already well versed in the operations supported by those help functions and, if necessary, the detachment of the computer itself from the audio mixing apparatus.

What is claimed is:

1. An assist display apparatus for displaying help information on a monitor screen in association with a plurality of controls which are arranged on an audio mixing apparatus and which are operable by a user for mixing audio signals, the assist display apparatus comprising:
a help information storage section that stores help information of each of said plurality of said controls arranged on said audio mixing apparatus, the help information being capable of assisting the user in operating the controls;
a receiving section that receives an operation event caused by one of said plurality of said controls which has been operated by the user on said audio mixing apparatus; and
a display section that can present a multiple of frames including an instruction frame and other frame in an overlap manner with each other on the monitor screen and that displays the help information associated with said operation event received from said audio mixing apparatus in the instruction frame disposed on top of other frame.

2. The assist display apparatus according to claim 1, wherein the display section displaces said instruction frame to back of other frame when a predetermined time has passed after a point of time at which said help information was displayed in said instruction frame.

3. The assist display apparatus according to claim 1, wherein the display section closes said instruction frame when a predetermined time has passed after a point of time at which said help information was displayed in said instruction frame.

4. The assist display apparatus according to claim 1, wherein the display section hides said instruction frame from a view when a predetermined time has passed after a point of time at which said help information was displayed in said instruction frame.

5. The assist display apparatus according to claim 1, wherein the display section reduces a size of said instruction frame or relocates a position of said instruction frame such that the instruction frame does not hinder a view of other frame, when a predetermined time has passed after a point of time at which said help information was displayed in said instruction frame.

6. An assist display apparatus for displaying help information on a monitor screen in association with a plurality of controls which are arranged on an audio mixing apparatus and which are operable by a user for mixing audio signals, the assist display apparatus comprising:
a help information storage section that stores help information of each of said plurality of said controls arranged on said audio mixing apparatus, the help information being capable of assisting the user in operating the controls;
a setting section that sets on or off of an instruction mode;
a receiving section that receives an operation event caused by one of said plurality of said controls which has been operated by the user on said audio mixing apparatus; and
a display section that can present a multiple of frames including an instruction frame and other frame in an overlap manner with each other on the monitor screen, and that operates when said instruction mode is on for displaying the help information associated with said operation event received from said audio mixing apparatus in the instruction frame disposed on top of other frame.

7. The assist display apparatus according to claim 6, wherein the display section displaces said instruction frame to back of other frame when a predetermined time has passed after a point of time at which said help information was displayed in said instruction frame.

8. The assist display apparatus according to claim 6, wherein the display section closes said instruction frame when a predetermined time has passed after a point of time at which said help information was displayed in said instruction frame.

9. The assist display apparatus according to claim 6, wherein the display section hides said instruction frame from a view when a predetermined time has passed after a point of time at which said help information was displayed in said instruction frame.

10. The assist display apparatus according to claim 6, wherein the display section reduces a size of said instruction frame or relocates a position of said instruction frame such that the instruction frame does not hinder a view of other frame, when a predetermined time has passed after a point of time at which said help information was displayed in said instruction frame.

11. An assist display program designed for displaying help information on a monitor screen in association with a plurality of controls which are arranged on an audio mixing apparatus and which are operable by a user for mixing audio signals, the help information being capable of assisting the user in operating the controls and being stored in a storage in correspondence to each of said plurality of said controls, the assist display program being executable by a computer connected to said audio mixing apparatus via a communication interface for carrying out a process comprising the steps of:
receiving an operation event caused by one of said plurality of said controls which has been operated by the user on said audio mixing apparatus;
reading out the help information corresponding to the control operated by the user from the storage in response to the operation event; and
displaying the read help information associated with said operation event received from said audio mixing apparatus in an instruction frame disposed over other frame on the monitor screen.

12. The assist display program according to claim 11, wherein the displaying step displaces said instruction frame to back of other frame when a predetermined time has passed after a point of time at which said help information was displayed in said instruction frame.

13. An assist display program designed for displaying help information on a monitor screen in association with a plurality of controls which are arranged on an audio mixing apparatus and which are operable by a user for mixing audio signals, the help information being capable of assisting the user in operating the controls and being stored in a storage in correspondence to each of said plurality of said controls, the assist display program being executable by a computer connected to said audio mixing apparatus via a communication interface for carrying out a process comprising the steps of:
setting on or off of an instruction mode;
receiving an operation event caused by one of said plurality of said controls which has been operated by the user on said audio mixing apparatus;
reading out the help information corresponding to the control operated by the user from the storage in response to the operation event; and
displaying the read help information associated with said operation event received from said audio mixing apparatus, when said instruction mode is on, in an instruction frame disposed over other frame on the monitor screen.

14. The assist display program according to claim 13, wherein the displaying step displaces said instruction frame to back of other frame when a predetermined time has passed after a point of time at which said help information was displayed in said instruction frame.
